(19) United States
(12) Patent Application Publication
(10) Pub. No.: US 2006/0007464 A1
(43) Pub. Date: Jan. 12, 2006

(54) Structured data update and transformation system

(76) Inventor: Michael F. Percey, Elverson, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/034,290

(22) Filed: Jan. 12, 2005

Related U.S. Application Data
(60) Provisional application No. 60/584,018, filed on Jun. 30, 2004.

(51) Int. Cl. G06F 15/00

(52) U.S. Cl. 358/1.13

(57) ABSTRACT

A structured data transformation system includes a source of first data determining an existing hierarchically ordered data structure. A source of transformation data determines transformations to be performed to convert the existing hierarchically ordered data structure to a target different hierarchically ordered data structure. A validation processor examines the first data to validate the transformation data is able to successfully process the first data by determining data elements, required for the transformation, exist in the first data. A transformation processor initiates transformation of the first data into second data representing the target different hierarchically ordered data structure using the transformation data in response to successful validation.

This is a non-provisional application of provisional application Ser. No. 60/584,018 by M. F. Percey filed Jun. 30, 2004.

### FIELD OF THE INVENTION

This invention concerns a system for transforming data records having a first data structure to data records having a different second data structure.

### BACKGROUND INFORMATION

In data processing it is commonly necessary to update stored data structures, documents or electronic forms. In existing systems this task is typically performed by manual update of data and executable procedures associated with the stored data structures, documents and electronic forms. In such systems it is difficult and time consuming to cleanly separate the modification of a container (data structure, document, etc.), from transformation of its contained data. Typically, data in an existing data structure is transformed to a desired new data structure by exporting the data, modifying the structure, transforming the exported data from the existing structure to the new structure, and importing the transformed data for storage and use by an executable. This process usually involves burdensome manual operations, is resource intensive and prone to error. The process is also relatively slow which results in data being unavailable for access for extended time periods and usually leaves multiple data transformation issues to be resolved following importation of the transformed data. A system according to invention principles addresses these problems and derivative problems.

### SUMMARY OF THE INVENTION

A system modifies a transformation specification that determines an existing data structure in a relational database, in order to meet the requirements of a set of predetermined specifications and transforms data content in an original data structure to support requirements of a desired target data structure. A structured data transformation system includes a source of first data (e.g., a transformation specification such as a schema) determining an existing hierarchically ordered data structure. A source of transformation data (e.g., an XML document) determines transformations to be performed to convert the existing hierarchically ordered data structure to a target different hierarchically ordered data structure. A validation processor examines the first data to validate the transformation data is able to successfully process the first data by determining data elements, required for the transformation, exist in the first data. A transformation processor (e.g., a schema transformation engine) initiates transformation of the first data into second data (e.g., an XML schema) representing the target different hierarchically ordered data structure using the transformation data in response to successful validation.

### BRIEF DESCRIPTION OF THE DRAWING

FIG. 1 shows a structured data transformation system, according to invention principles.

FIG. 2 shows a flowchart of a structured data transformation process, according to invention principles.

FIG. 5 shows a data structure created from the merger of the data structures of FIGS. 3 and 4 produced by the transformation system of FIG. 1, according to invention principles.

FIG. 6 shows a table used in data determining a master file data structure updated by the transformation system of FIG. 1, according to invention principles.

FIG. 7 shows a table determining Tables used in data determining a master file data structure updated by the transformation system of FIG. 1, according to invention principles.

FIG. 8 shows a table determining the Fields within a Table used in data determining a master file data structure updated by the transformation system of FIG. 1, according to invention principles.

FIG. 9 shows a table determining the data elements within a Field of a Table used in data determining a master file data structure updated by the transformation system of FIG. 1, according to invention principles.

FIG. 10 shows a table determining data records used in data determining a master file data structure updated by the transformation system of FIG. 1, according to invention principles.

FIG. 11 shows a record table associating a table (identified by a table identifier as shown in FIG. 7) with a record, according to invention principles.

FIG. 12 shows a RecordField table associating the data structure defined field (identified by a Field identifier FieldID as shown in FIG. 8) with a record, according to invention principles.

FIG. 13 shows a RecordValue table associating a data element (identified by an Element identifier ElementID as shown in FIG. 9) with a record, according to invention principles.

FIGS. 14 and 15 show data tables containing data in records in the master file data structure updated by the transformation system of FIG. 1, according to invention principles.

FIGS. 16 and 17 show XML schemas determining the hierarchically ordered data structures of FIG. 3 and 4 respectively, according to invention principles.

FIG. 18 shows transformation data (an XML schema) for automatically transforming the data structures represented in FIGS. 16 and 17 into the XML schema of FIG. 19 determining the merged hierarchically ordered data structure of FIG. 5, according to invention principles.

### DETAILED DESCRIPTION OF INVENTION

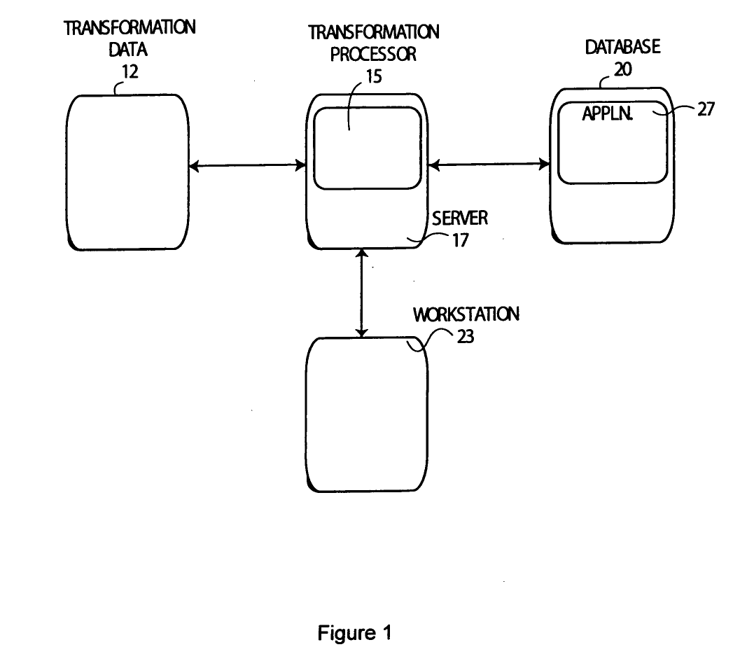

FIG. 1 shows a structured data transformation system. Transformation processor 15 (e.g., a schema transformation engine) executing on server 17 uses transformation data 12 (e.g., an XML document) in automatically transforming first data (e.g., a schema) determining an existing hierarchically ordered data structure (e.g., of a document or form) into second data (e.g., a schema) representing a target different hierarchically ordered data structure. The transformation occurs within database 20 via database management application 27. Transformation data 12 determines transformations to be performed to convert the existing hierarchically ordered data structure to the target different hierarchically ordered data structure. Transformation processor 15 examines the first data to validate the transformation data is able to successfully process the first data by determining data elements that are required for the transformation exist in the first data. The system performs data structure and data content transformations and facilitates upgrade of an existing document in a database to incorporate a new data structure and new data content in response to transformation data (e.g., a transformation specification).

The transformation system applies a new transformation specification (transformation data 12) to update a data structure and corresponding existing structure determination data of an existing document. The content data for the existing document is retrieved from database 20 and edited to match the new transformation specification and the updated data is stored back into database 20 in the new structure. Transformation data 12 is generated by a Transformation Specification generation application in transformation processor 15. The automatic transformation system reduces transformation resources required, transformation time and the period the data being transformed is unavailable for use as well as the number and scope of data issues that need resolution upon completion of transformation. The data transformation system maintains transformation data 12 within a database 20 (or in another embodiment within another repository) and provides an efficient method to perform an in-place transformation of data within database 20. Records (that comprise data content for inclusion in the data structure) are also stored in database 20 and are also transformed for incorporation in a transformed data structure.

The first data determining an existing hierarchically ordered data structure of a schema and transformation data 12 comprise Extensible Markup Language (XML) compatible data, defined by the World Wide Web Consortium (W3C). The W3C defines an XML Schema that specifies how to formally describe elements in an XML document. An XML Schema provides a means for defining the structure, content and semantics of XML documents. In other embodiments, the first data and transformation data 12 comprise SGML compatible data, HTML compatible data or other structured language data. The XML schema, for example, is used by transformation processor 15 to verify that items of content within the input documents adhere to expected constraints. For example, the first data XML schema may require a structure composed of a collection of nested Tables, each containing a collection of Fields (that cannot be nested), with each Field composed of a collection of Data Elements. The transformation data 12 XML Schema codifies these constraints and is used by the transformation processor 15 to validate the transformation data is able to successfully process the first data.

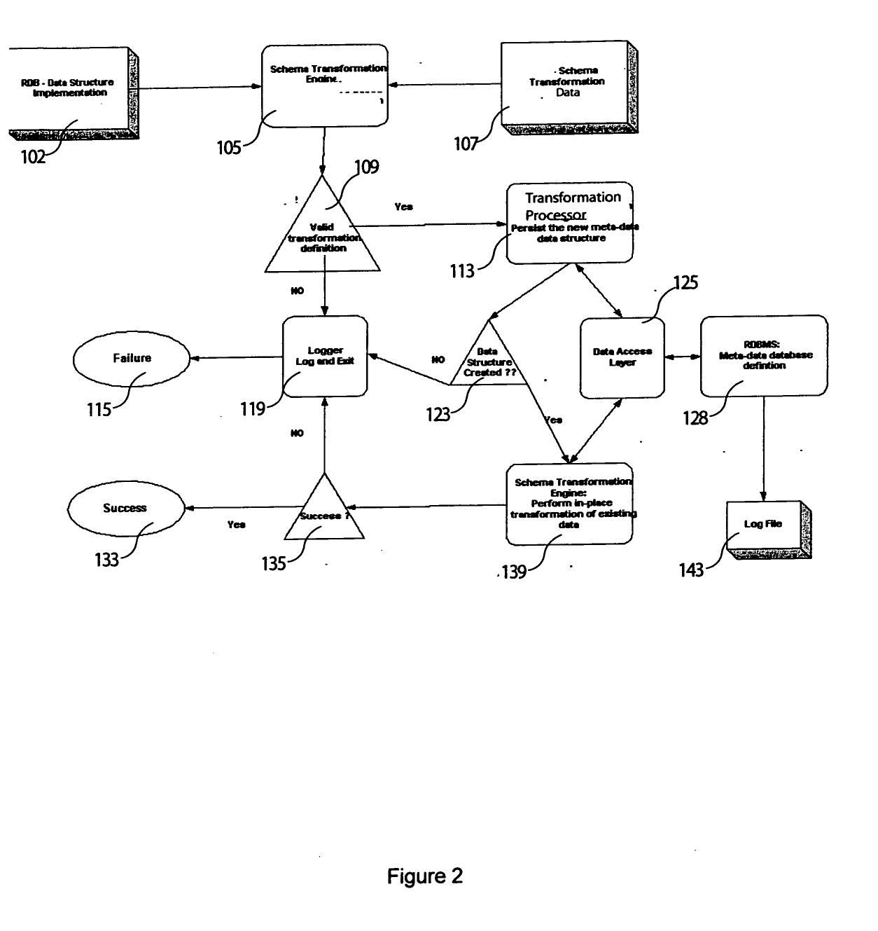

FIG. 2 shows a flowchart of a process for transforming structured data performed by transformation processor 15 in conjunction with database management application 27 of FIG. 1. The FIG. 2 process is a background process that advantageously does not require user interaction. In response to initiation of the process, an application user interface image is generated for display on workstation 23 (FIG. 1) that provides information regarding the progress of the transformation.

Transformation processor 15 modifies first data determining an existing hierarchically ordered data structure in relational database 20 to meet the requirements of transformation data 12 (e.g., a set of predefined specifications) and transforms data in the existing data structure to support requirements of a desired target data structure. The existing hierarchically ordered data structure includes, parent, child and grandchild data elements and comprises a data record (e.g., a table), data rows and columns within a record and data fields within an individual row and within an individual column. Transformation processor 15 in step 105 acquires first data 102 (FIG. 2) from database 20 and acquires transformation data 107 for storage into memory. Transformation processor 15 examines the first data in step 109 to validate transformation data 12 is able to successfully process the first data by determining data elements that are required for the transformation exist in the first data. If transformation data 12 is valid, transformation processor 15 continues with transformation processing in step 113. If transformation data 12 is invalid, transformation processor 15 in step 119 records an error, displays a message to the user, and exits in step 115.

Transformation processor 15 in step 113 uses transformation data 12 to modify the first data to create second data representing a target different hierarchically ordered data structure in database 20. For this purpose transformation processor 15 in step 125 dynamically links to a Data Access Layer to perform data input and output (I/O) operations in communicating with application 27 (a Relational Database Management Application) used to manage access to database 20. Transformation processor 15 in step 128, via the data access layer and application 27, adds and removes meta data structure objects (tables, fields and elements) in database 20 to create the second data representing the target different hierarchically ordered data structure. Specifically, transformation processor 15 merges data elements, splits a data element into multiple data elements, adds a data element and deletes a data element in creating the second data. Application 27 in step 143 records information identifying data changes made in transforming the first data into second data and information identifying a user associated with the transformation.

Transformation processor 15 verifies in step 123 that the second data representing the target different hierarchically ordered data structure has been successfully created in database 20. If the second data is invalid, transformation processor 15 records an error in step 119 and displays a failure message to a user and exits in step 115. If the second data is valid, transformation processor 15 continues with the transformation in step 139 by transforming content data for inclusion in the target different hierarchically ordered data structure using transformation data 12 in response to successful validation. Processor 15 transforms the content data by changing format of data conveyed in a data element. Transformation processor 15 incorporates the transformed content data records into the target different hierarchically ordered data structure by dynamically linking to the Data Access Layer in step 125 to perform the required I/O operations with application 27. Transformation processor 15 retrieves a list of data records stored in the existing hierarchically ordered data structure (determined by the first data) in relational database 20. Transformation processor 15 uses transformation data 12 to modify each data record to conform to the requirements of the target different hierarchically ordered data structure. This includes converting the data type of an existing value, deleting a data value, inserting a default value for a new element, parsing an existing data value into new distinct values, and concatenating existing data values into a single value, for example. Application 27 in step 143 records information identifying data changes made in transforming the first data into second data and information identifying a user associated with the transformation. If the second data is invalid, transformation processor 15 records an error in step 119 and displays a failure message to a user and exits in step 115.

Transformation processor 15 in step 135 verifies that the data records are modified to conform to the requirements of the target different hierarchically ordered data structure and successfully incorporated into the target different hierarchically ordered data structure. If the data record transformation processing completed successfully the transformation processor 15 logs successful completion, displays a message to the user, and exits in step 133. If the data record transformation processing did not complete successfully the transformation processor 15 logs an error in step 119, displays a message to the user, and exits in step 115.

The automatic transformation of data structure and data content shown in the FIG. 2 process is usable by systems that may define a data structure within a meta-data database, with XML, or some other structured language such as SGML or HTML. When a hierarchical data structure needs to be changed to support additional functions of an application or to track more data for a system, transformation processor 15 upgrades transformation data 12 and initiates the transformation process of FIG. 2. Transformation processor 15 advantageously enables efficient and accelerated upgrades to existing data structures. The transformation system of FIG. 1 and process of FIG. 2 are used in updating a central store of common master file data such as patient medical records and financial records and other medical data maintained in a database. Transformation processor 15 and the Transformation Specification generation application within transformation processor 15 (used for updating or creating transformation data 12) are used to upgrade structured data such as master file data. The master file data comprising first data representing an existing hierarchical data structure is updated (transformed) to second data representing a target different hierarchical data structure. The data content in the existing hierarchical data structure is also updated (transformed) to be compatible with the second data representing a target different hierarchical data structure and is incorporated in the target different hierarchical data structure. Medical master file hierarchical data structures need to be changed to support new application functions, or accommodate new or changed federal or local government requirements, international requirements etc.

As an example, it is necessary to change a Doctor Master file that contains details of doctors resident at a hospital to support a new version of an application that uses doctor accreditation information that is not currently stored in the master file. A Doctor Master file currently in use at multiple sites requires an upgrade. Transformation processor 15 performs that upgrade without any loss of data. As another example, a new Doctor Master file combines an area code and phone number into a single element. Transformation processor 15 transforms (updates) the old version Doctor Master file to be compatible with the new Doctor master file.

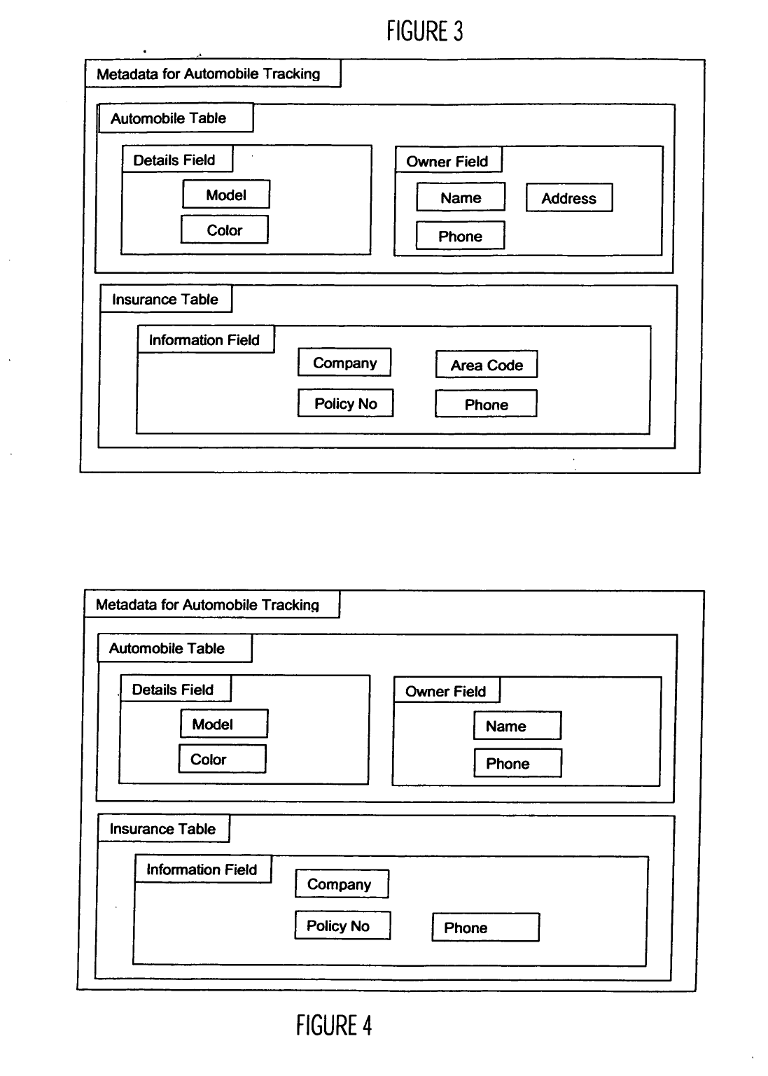

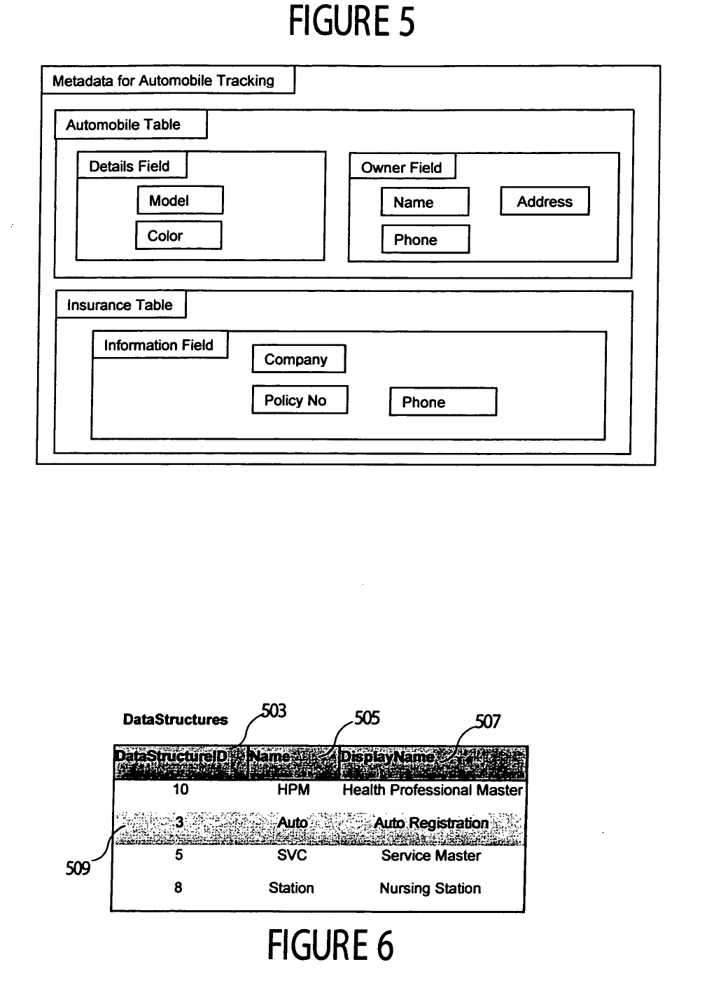

FIG. 5 shows a data structure used to record household automobile information created from the merger of data elements of data structures of FIGS. 3 and 4 produced by the transformation system of FIG. 1. The data structure is composed of two tables, Automobile and Insurance. The Automobile table contains two Fields, Details and Owner. The Details field is comprised of two data elements, Model and Color. The Owner field contains three data elements, Name, Phone, and Address. The Insurance table has one field, Information. The Information field is composed of three data elements, Company, Policy Number and Phone. The Transformation Specification generation application in transformation processor 15 (FIG. 1) creates transformation data 12 used by transformation processor 15 to transform first data determining existing hierarchically ordered data structures depicted in FIGS. 3 and 4 into second data representing the target merged different hierarchically ordered data structure of FIG. 5. The FIG. 3 data structure differs from the FIG. 5 data structure in that it has an Area Code element in the Information Field. The FIG. 4 data structure differs from the FIG. 5 data structure in that it omits an Address element in the Owner Field.

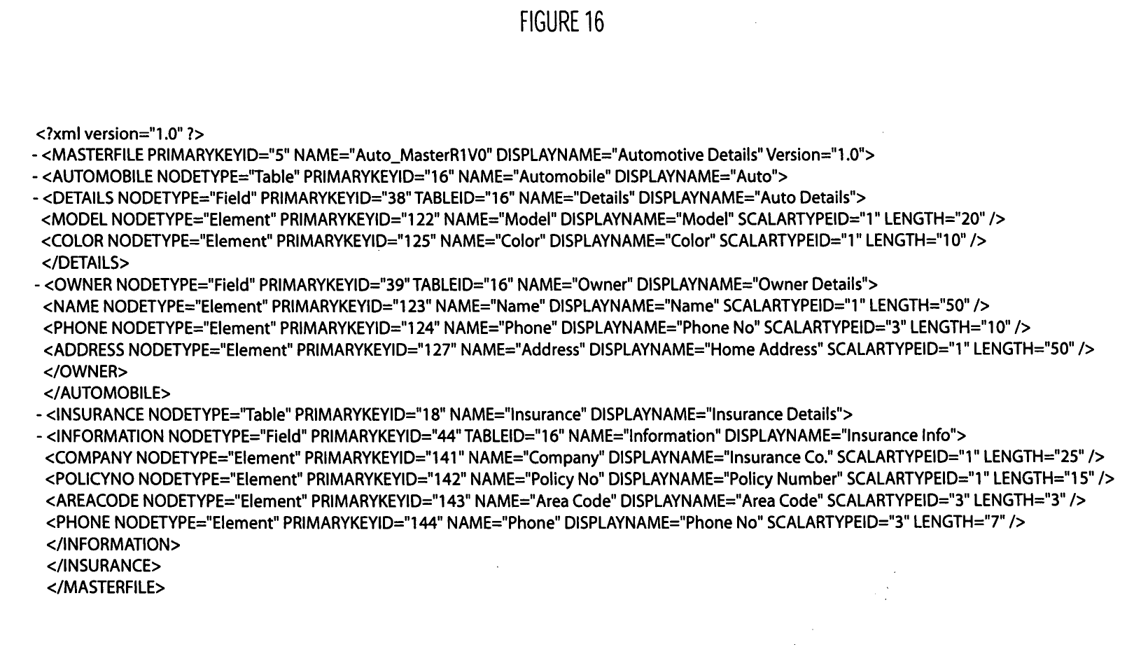

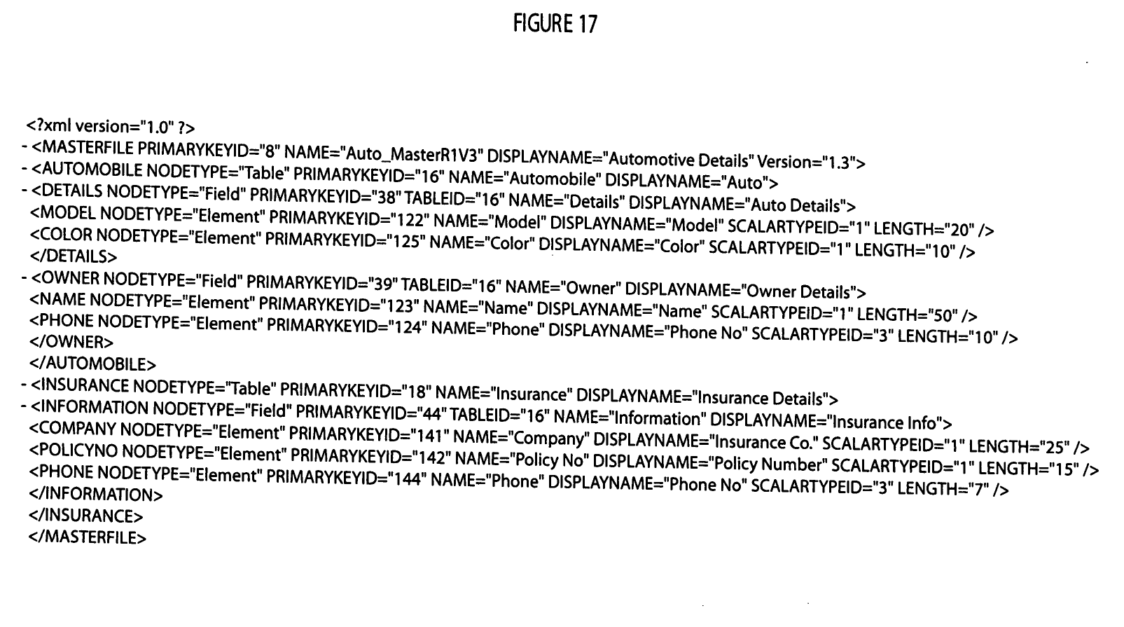

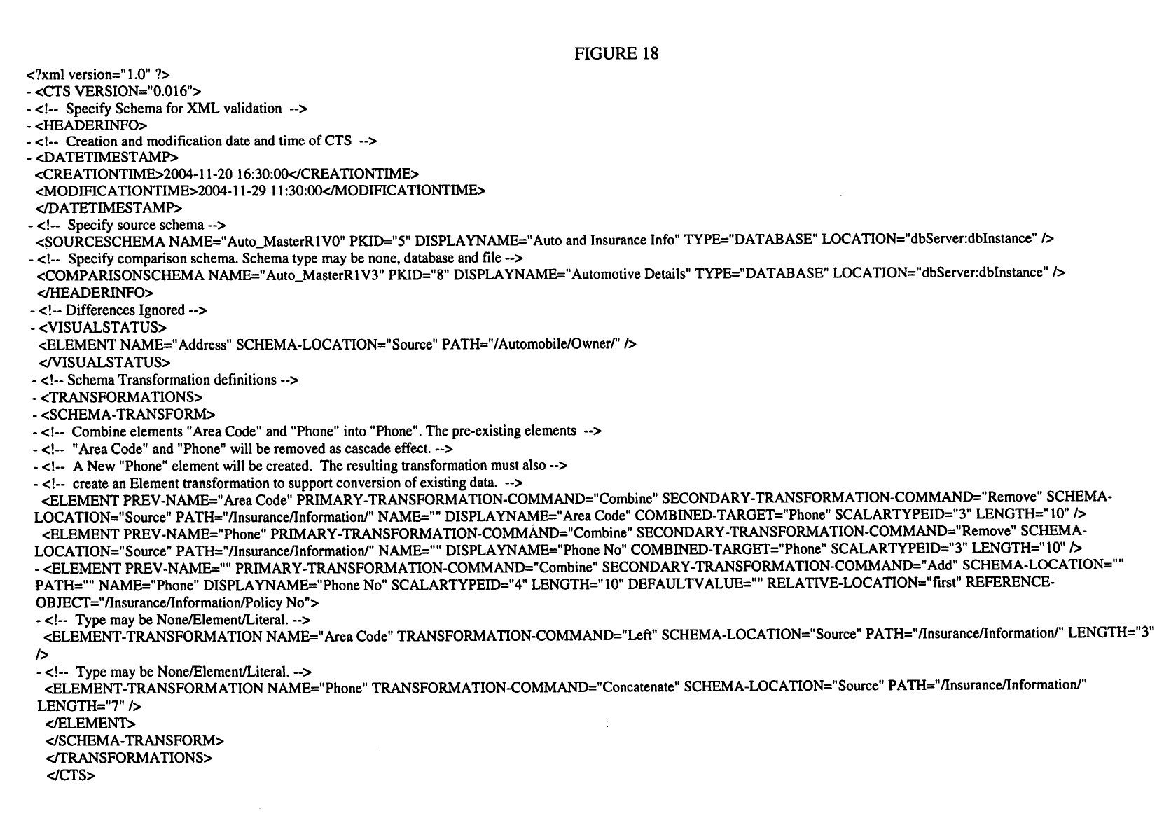

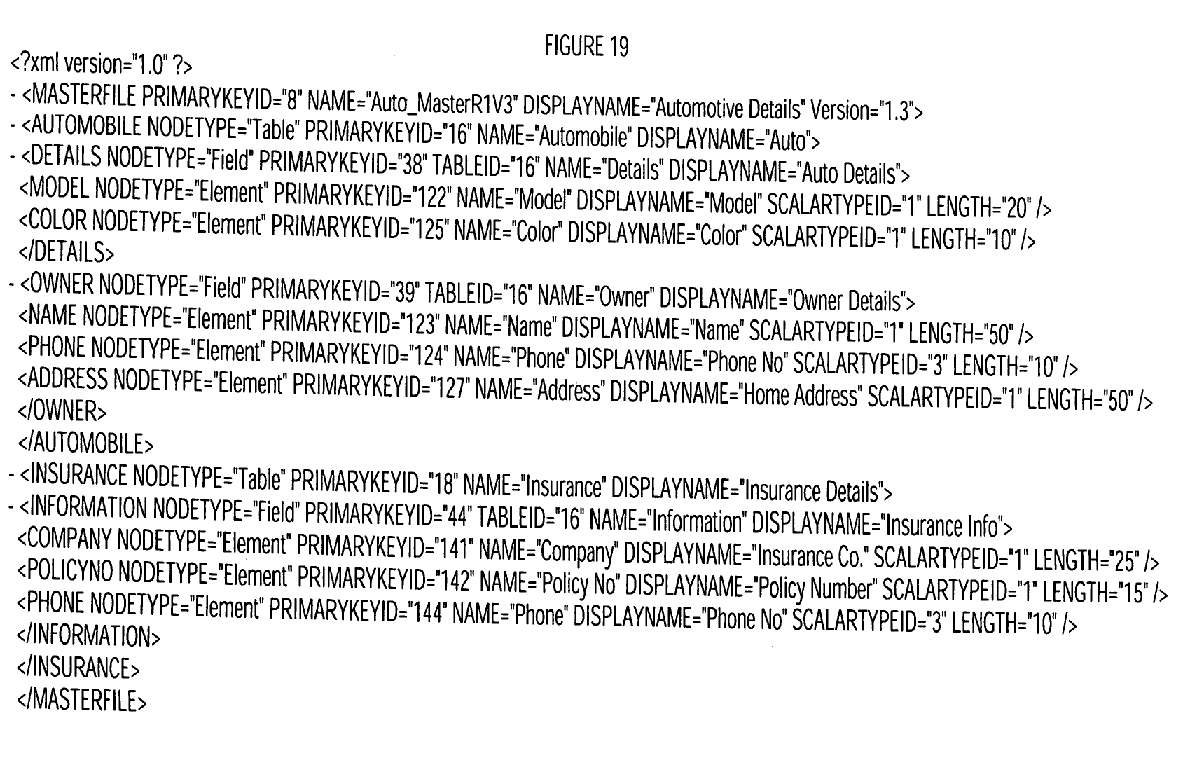

FIGS. 16 and 17 show XML schemas (comprising master file schemas) determining the hierarchically ordered data structures of FIG. 3 and 4 respectively. Transformation processor 15 executing on server 17 uses transformation data 12 (exemplified in FIG. 18) for automatically transforming the existing hierarchically ordered data structure into the XML schema of FIG. 19 determining the merged hierarchically ordered data structure of FIG. 5. Transformation processor 15 uses the created transformation data 12 (exemplified in FIG. 18) to create the target merged different hierarchically ordered data structure in database 20. The created transformation data 12 is also used by transformation processor 15 to transform data records for storage in the FIG. 5 data structure. For instance, the Insurance Table Information Field Policy No data element is modified from an integer data type to an alphanumeric data type. The Automotive Table Owner Field Name data element is also changed from a length of 20 to a length of 40 characters, for example. Upon creation of the merged data structure of FIG. 5 in database 20, transformation processor 15 transforms data records in place to comply with the format requirements of created transformation data 12. The transformation process occurs while database 20 is operational The transformation process advantageously minimizes application unavailability and the export, transformation and import of the data records.

In exemplary operation, an executable application uses data in a master file in a database that includes first data determining the hierarchical data structure of the master file. Data records that conform to the data structure determined by the first data are also stored in the database for incorporation in the data structure. FIGS. 6-15 show data structure tables determining a master file data structure produced by a transformation process performed by transformation processor 15. In another embodiment the data structure tables of FIGS. 6-15 may be manually created and edited. Transformation processor 15 uses the XML representation of such data structure tables to create transformation data 12 exemplified in FIG. 18. Specifically, the XML representations of these structures as presented in FIGS. 16 and 17 are used to create the Transformation Specification shown in FIG. 18. For this purpose, the XML representation of the two different hierarchical data structures stored in database 20 and associated with FIGS. 3 and 4 are processed by Transformation processor 15. Transformation processor 15 compares the XML documents FIGS. 16 and 17 and provides a user interface by which a user determines how these two different hierarchical data structures are merged to create the merged hierarchically ordered data structure associated with FIG. 5 and represented by the XML schema of FIG. 19. The entered user instructions are recorded in transformation data 12 (the transformation specification). In another embodiment the user instructions are automatically generated and the generation of transformation data 12 is wholly automated.

FIG. 6 shows a table used in data determining a master file data structure updated by the transformation system of FIG. 1. Specifically, FIG. 6 shows a DataStructures table that identifies a master file data structure with an identifier (e.g., DataStructureID 10) in column 503 and corresponding name (HPM) and display name (Health Professional Master) in columns 505 and 507 respectively. The DataStructureID is used as a unique identifier, and is referenced by other tables. The Auto Registration data structure of row 509 of FIG. 6 is linked with other data structure items discussed in subsequent Figures.

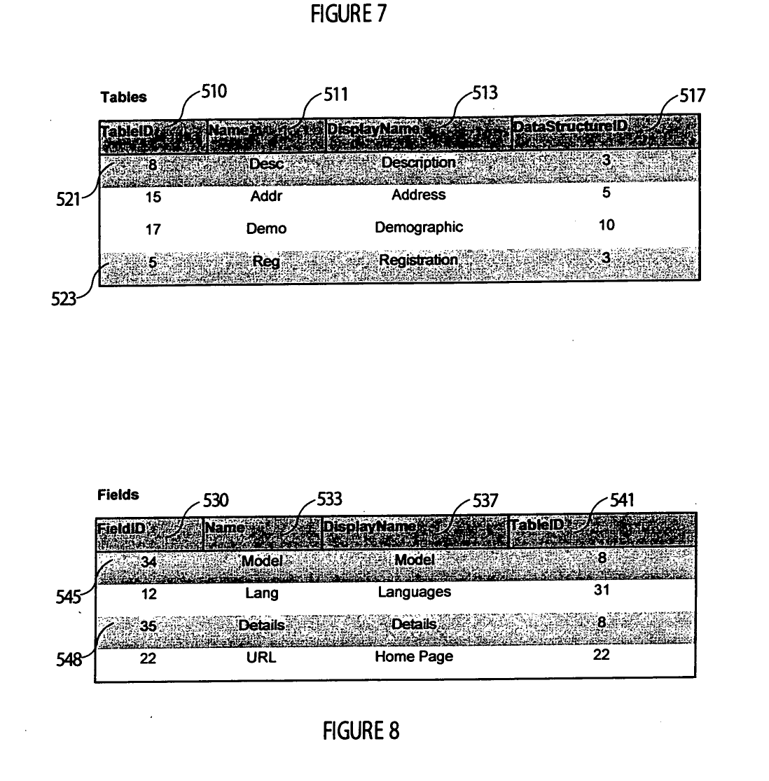

FIG. 7 shows a table determining Tables used in data determining a master file data structure updated by the transformation process. Specifically, FIG. 7 shows a Tables table that defines the tables within the master file data structure using an identifier TableID in column 510, a name in column 511, a display name in column 513 and a DataStructureID in column 517. The TableID (e.g., 5) is used as a unique table identifier and is referenced by other tables. An individual table definition contains a reference to its parent data structure using its DataStructureID 517. In this example, Description and Registration tables (rows 521 and 523 of FIG. 6) are defined within the Auto Registration data structure of row 509 of FIG. 6.

FIG. 8 shows a table determining the Fields within a Table used in data determining a master file data structure updated by the transformation system of FIG. 1. Specifically, FIG. 8 shows a Fields table that defines the Fields within tables in the master file data structure using an identifier FieldID in column 530, a name in column 533, a display name in column 537 and a TableID in column 541. The FieldID (e.g., 34) is used as a unique field identifier referenced in other tables. An individual Field table definition contains a reference to its parent data structure using its TableID 541. In this example, Model and Details fields (rows 545 and 548) are defined within the Description table of row 521 of FIG. 7.

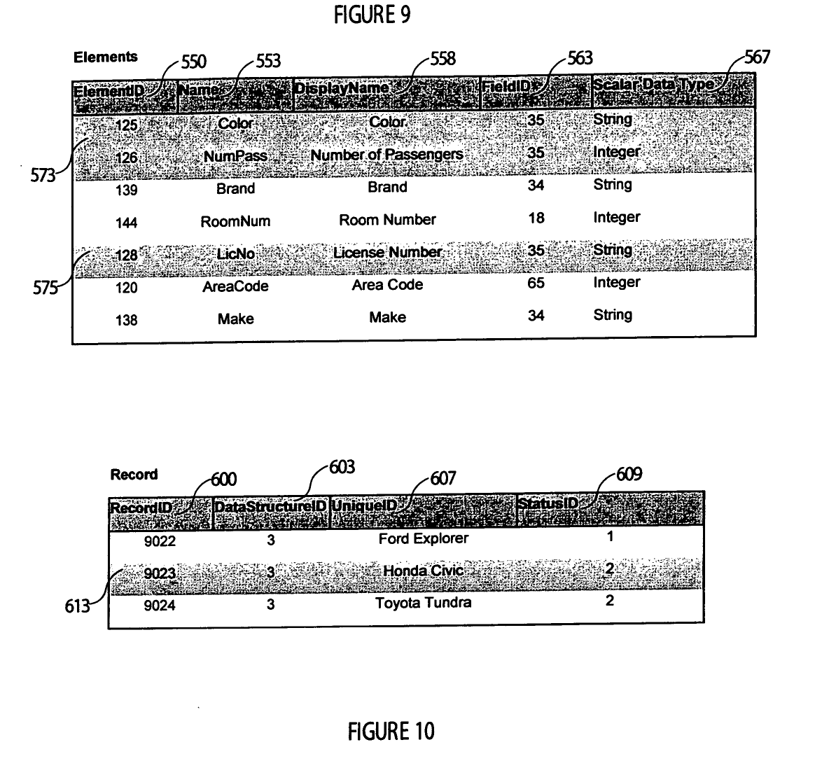

FIG. 9 shows a table determining the data elements within a Field used in data determining a master file data structure updated by the transformation system of FIG. 1. Specifically, FIG. 9 shows an Elements table that defines the data elements within Fields in the master file data structure using an identifier ElementID in column 550, a name in column 553, a display name in column 558 and a FieldID in column 563 and scalar data type in column 567. The ElementID (e.g., 125) is used as a unique element identifier referenced in other tables. An individual element contains a reference to its parent Field using its FieldID 563. In this example, the Color, Number of Passengers, and License Number elements are defined within the Details field (row 548) of FIG. 8. The tables of FIGS. 6-9 determine the hierarchical data structure that is modified so that the data structure represents the specifications of transformation data 12. Tables of FIGS. 10-15 represent the data stored in the hierarchical data structure that is to be modified. This data is updated to be compatible with the modified structure.

FIG. 10 shows a table determining data records used in data determining a master file data structure updated by the transformation system of FIG. 1. The records are stored in database 20 and conform to the master file data structure. The FIG. 10 database table definition enables storage of records conforming to the master file data structure. FIG. 10 shows a Records table that determines the Records incorporated in the master file data structure using a RecordID identifier in column 600, a DataStructureID in column 603 indicating the data structure that the record is associated with and a UniqueID in column 607 acting as a unique identifier within the record set. The FIG. 10 table also includes a StatusID in column 609. The RecordID (e.g., 9022) is used as record identifier referenced in other tables. In this example, the Honda Civic record (row 613) is highlighted as being of interest and is stored/related to the Auto Registration data structure in FIG. 6 (i.e. Column 603, DataStuctureID 3).

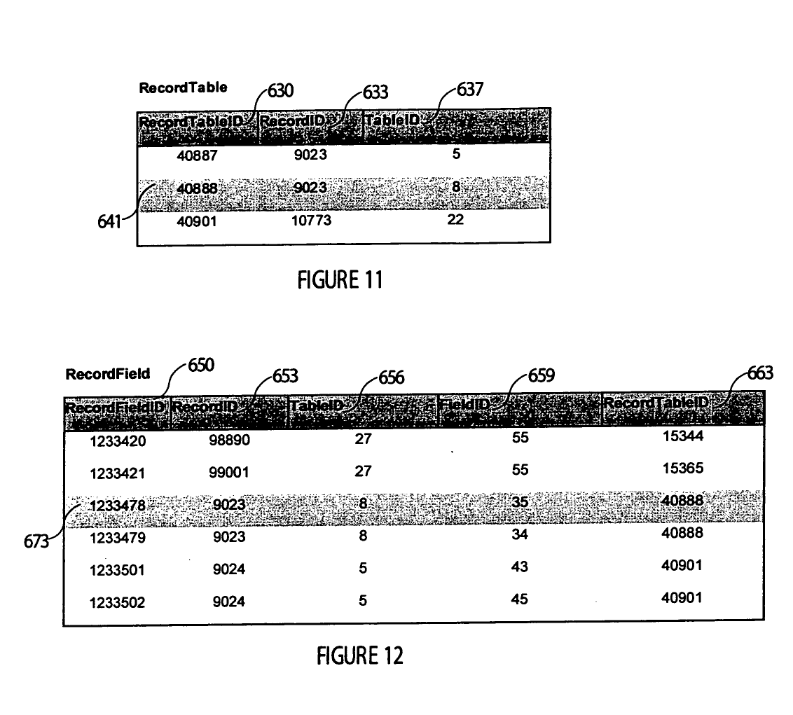

FIG. 11 shows a RecordTable table associating the data structure defined table (identified by a table identifier TableID as shown in FIG. 7) with a record. The FIG. 11 record table is used in data determining (and containing data incorporated in records in) a master file data structure updated by the transformation system of FIG. 1. The FIG. 11 RecordTable table associates a RecordTableID in column 630 and that is referenced by other tables with, a RecordID in column 633 and with and a TableID in column 637. In this example, a RecordTableID 40888 in row 641 identifies a record of interest and is stored/related to the Honda Civic Record in FIG. 10 (i.e. Column 633, RecordID 9023).

FIG. 12 shows a RecordField table associating the data structure defined field (identified by a Field identifier FieldID as shown in FIG. 8) with a record. The FIG. 12 RecordField table is used in data determining (and containing data incorporated in records in) a master file data structure updated by the transformation system of FIG. 1. The FIG. 12 RecordField table associates a RecordFieldID in column 650 with, a RecordID in column 653, a TableID in column 656, a FieldID in column 659 and with a RecordTableID in column 663. The RecordFieldID is referenced by other tables. In this example, the RecordFieldID 1233478 in row 673 identifies a record of interest and is stored/related to a RecordTable entry in FIG. 11 (i.e. Column 663, RecordID 4088).

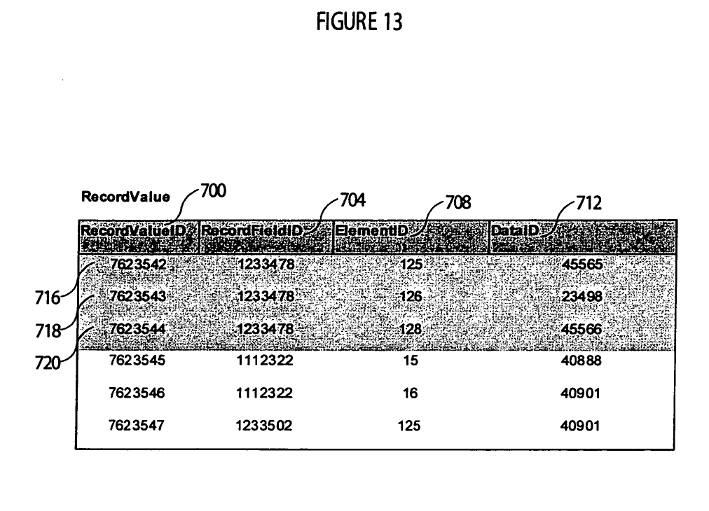

FIG. 13 shows a RecordValue table associating the data structure defined data element (identified by an Element identifier ElementID as shown in FIG. 9) with a record used in data determining (and containing data incorporated in records in) a master file data structure updated by the transformation system of FIG. 1. The FIG. 13 RecordValue table associates a RecordValueID in column 700 with, a RecordFieldID in column 704, an ElementID in column 708 and with a DataID in column 712. The RecordValueID is referenced by other tables. In this example, the RecordValueID(s) 7623542, 7623543, and 7623544 in rows 716-720 identify the record data values of interest that are stored/related to a RecordField entry in FIG. 12 (i.e. Column 704, RecordID 1233478). A RecordValue table also references a data element (i.e., an ElementID). In this example, the Color, Number of Passengers, and License Number elements are referenced. These references are used to determine the scalar data table where the record values are stored.

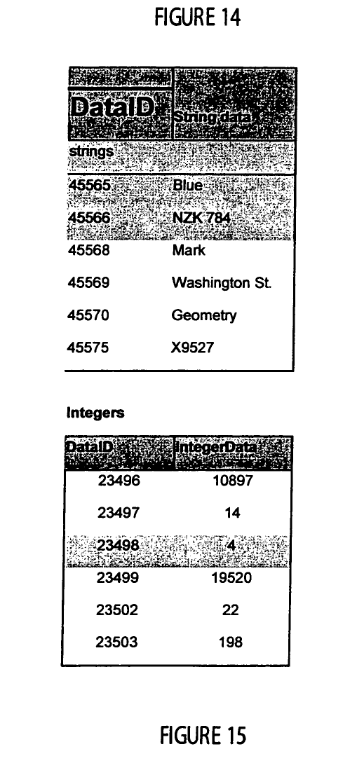

FIGS. 14 and 15 show data tables containing data incorporated in records in the master file data structure updated by the transformation system of FIG. 1. FIG. 14 shows record data values in a string data column for corresponding record data items identified in an adjacent DataID column. The FIG. 14 DataID identifiers are associated with an ElementID in column 708 for the FIG. 13 RecordValue table via the DataID in column 712. FIG. 15 shows record data values in an integer data column for corresponding record data items identified in an adjacent DataID column. The FIG. 15 DataID identifiers are associated with an ElementID in column 708 for the FIG. 13 RecordValue table via the DataID in column 712. A scalar data table, as exemplified in the Strings and Integers tables of FIGS. 14 and 15, is defined for each data type supported by an application. As shown in FIGS. 14 and 15, Color is a string, a Number of Passengers is an integer, and License is a string. Specifically, the FIG. 14 Strings tables contains DataID 45565 (Blue (Color)), DataID 45566 (NZK 784 (License Number)) and the Integers tables contains DataID 23498 (4—Number of Passengers).

The system, data structures and processes presented herein are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the system and process of FIGS. 1 and 2 respectively, may be implemented in hardware, software or a combination of both.

What is claimed is:

1. A structured data transformation system, comprising:
a source of first data determining an existing hierarchically ordered data structure;
a source of transformation data determining transformations to be performed to convert said existing hierarchically ordered data structure to a target different hierarchically ordered data structure;
a validation processor for examining said first data to validate said transformation data is able to successfully process said first data by determining data elements required for said transformation exist in said first data; and
a transformation processor for initiating transformation of said first data into second data representing said target different hierarchically ordered data structure using said transformation data in response to successful validation.

2. A system according to claim 1, including
a source of content data for inclusion in said existing hierarchically ordered data structure and
said transformation processor transforms said content data for inclusion in said target different hierarchically ordered data structure using said transformation data in response to successful validation.

3. A system according to claim 2, including
said transformation processor incorporates said transformed content data into said target different hierarchically ordered data structure.

4. A system according to claim 1, wherein
said first data comprises at least one of, (a) XML compatible data, (b) SGML compatible data and (c) HTML compatible data.

5. A system according to claim 1, wherein
said transformation data comprises at least one of, (a) XML compatible data, (b) SGML compatible data and (c) HTML compatible data.

6. A system according to claim 1, wherein
said first data and
said target different hierarchically ordered data structure are incorporated within a single database.

7. A system according to claim 1, wherein
said transformation includes at least one of, (a) merging data elements, (b) splitting a data element into multiple data elements and (c) adding a data element.

8. A system according to claim 1, wherein
said transformation includes at least one of, (a) deleting a data element and (b) changing format of data conveyed in a data element.

9. A system according to claim 1, wherein
said existing hierarchically ordered data structure including, parent, child and grandchild data elements, comprises a data table, a data row within a table and data fields within a row respectively.

10. A system according to claim 1, wherein
said existing hierarchically ordered data structure including, parent, child and grandchild data elements, comprises a data table, a data column within a table and data fields within a column respectively.

11. A system according to claim 1, wherein
said existing hierarchically ordered data structure including, parent, child and grandchild data elements, comprises a data record, a data row within a record and data fields within a row respectively.

12. A system according to claim 1, wherein
said existing hierarchically ordered data structure including, parent, child and grandchild data elements, comprises a data record, a data column within a record and data fields within a column respectively.

13. A system according to claim 1, including
an audit processor for recording information identifying data changes made in response to said transformation of said first data into second data and information identifying a user associated with said changes.

14. A structured data transformation system, comprising:
a source of first data determining an existing hierarchically ordered data structure and content data for inclusion in said existing hierarchically ordered data structure;
a source of transformation data determining transformations to be performed to convert said existing hierarchically ordered data structure to a target different hierarchically ordered data structure;
a validation processor for examining said first data to validate said transformation data is able to successfully process said first data by determining data elements required for said transformation exist in said first data; and
a transformation processor for transforming said first data into said target different hierarchically ordered data structure using said transformation data in response to successful validation and for transforming said content data for inclusion into said target different hierarchically ordered data structure using said transformation data.

15. A system according to claim 14, including
said transformation processor transforms said content data for inclusion into said target different hierarchically ordered data structure in response to a determination by said validation processor of successful creation of said target different hierarchically ordered data structure.

16. A system according to claim 14, wherein
said transformation includes at least one of, (a) merging data values, (b) splitting a data value into multiple data values, (c) adding a data value, (d) removing a data value, and (e) changing format of a data value conveyed in a data element.

17. A method for transforming structured data, comprising the activities of:
storing first data determining an existing hierarchically ordered data structure;
storing transformation data determining transformations to be performed to convert said existing hierarchically ordered data structure to a target different hierarchically ordered data structure;
examining said first data to validate said transformation data is able to successfully process said first data by determining data elements required for said transformation exist in said first data; and
initiating transformation of said first data into second data representing said target different hierarchically ordered data structure using said transformation data in response to successful validation.

18. A structured data transformation system, comprising the activities of:
storing first data determining an existing hierarchically ordered data structure and content data for inclusion in said existing hierarchically ordered data structure;
storing transformation data determining transformations to be performed to convert said existing hierarchically ordered data structure to a target different hierarchically ordered data structure;
examining said first data to validate said transformation data is able to successfully process said first data by determining data elements required for said transformation exist in said first data; and
transforming said first data into said target different hierarchically ordered data structure using said transformation data in response to successful validation; and
transforming said content data for inclusion into said target different hierarchically ordered data structure using said transformation data.
